(19) United States
(12) Patent Application Publication
(10) Pub. No.: US 2022/0358462 A1
(43) Pub. Date: Nov. 10, 2022

(54) CONTEXT AND RULE BASED DYNAMIC COMMUNICATION CHANNELS FOR COLLABORATION BETWEEN USERS

(71) Applicant: salesforce.com, inc., San Francisco, CA (US)

(72) Inventors: Graham OLDFIELD, London (GB); Alex YE, San Francisco, CA (US); Prithvi Krishnan PADMANABHAN, San Francisco, CA (US)

(73) Assignee: salesforce.com, inc., San Francisco, CA (US)

(21) Appl. No.: 17/315,844

(22) Filed: May 10, 2021

(51) Int. Cl. G06Q 10/10; G06F 16/9535; G06F 16/955; G06F 16/9538

(52) U.S. Cl. CPC G06Q 10/103; G06F 16/9535; G06F 16/9566; G06F 16/9538; G06N 20/00

(57) ABSTRACT

Providing expert help to a user comprises providing an application for execution on a mobile device of the user associated with an entity. A computer receives entity rules from the entity, the entity rules include a definition of how communication channels are created. The entity rules are stored in a rules database in association with the user. A help request initiated by the user through the application program and sent by the mobile device, the help request comprising a current context of the user comprising a user ID and a task ID of a current task. Using the entity rules, the current context is transformed into search parameters that are used to search a knowledge repository for experts having profiles that match the current context of the user. The entity rules are used to automatically create a communication channel between the user and the experts matching the current context.

### TECHNICAL FIELD

One or more implementations relate to the field of context-aware help systems in a network-based application program; and more specifically, to generation of context and rule based dynamic communication channels (e.g., short message service (SMS), video call, etc.) for collaboration between users.

### BACKGROUND ART

Most software, whether provided as a standalone application program, browser based, web based, within and/or as part of a platform or combination of the foregoing, provides a help functionality to assist a client of the software and/or a user of the client and/or application program (e.g., the user may use the application program or use a client that is engaged with the application program, or both). Getting help often requires opening a separate help application (e.g., it may be manually started, or automatically spawned). With the advent of prevalent network connections to the Internet and other networks, while preliminary or basic help documentation may be built in to the application program, more substantive help documentation is often located at a resource accessible over the Internet.

Seeking application program help, for example, results in accessing the documentation from a website. Sometimes an application program has a limited help interface and brings up a main access point for the help and the client then needs to indicate what program feature for which help is desired. Other times, the application program may provide a limited context sensitivity in that it may recognize the client is accessing a particular function of the application program and the help may automatically call up initial help for the particular function. To make use of the help the client needs to switch back and forth between the help system and the application program; this back-and-forth does not provide a smooth help experience. Workers, such as field service technicians work in a complex world where finding expert assistance at the right time has always been difficult, but has become increasingly more difficult.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 is a block diagram illustrating a rule and context-based system for collaboration between teams of users.

FIG. 2 is a flow diagram illustrating a process for automatic context-based matching of a user to a set of experts and creation of a communication channel.

FIG. 3 is a diagram illustrating the process of configuring entity-level rules by an admin computer.

FIG. 4 is a diagram illustrating processing of the communication channel configuration of the entity-level rules by the collaboration and knowledge platform.

FIG. 5 is a diagram illustrating processing of the collaboration channel event configuration of the entity-level rules by the collaboration and knowledge platform.

FIGS. 6A-6F are diagrams illustrating an example application program user interface (UI) for implementing the context and rule based dynamic communication channels according to one implementation.

FIG. 7A is a block diagram illustrating an electronic device 70 according to some example implementations.

FIG. 7B is a block diagram of a deployment environment according to some example implementations.

### DETAILED DESCRIPTION

The following description describes implementations for providing rule and context-based communication channels for collaboration between teams of users. Based on predefined rules and a help request sent from a user application specifying a current context of the user, a collaboration and knowledge platform 104 automatically selects a set of experts to collaborate with the requesting user based on the current context and automatically creates a communication channel between the user and set of experts so the user can collaborate with the experts and get expert help. Example types of communication channels may include short messaging service (SMS), a video call, an audio call, email and the like. The knowledge platform may also perform context-based matching of knowledge articles to the current context of the user to make further recommendations to the user. Accordingly, the disclosed implementations provide mobile device users with automatic context-based matching of experts and knowledge articles.

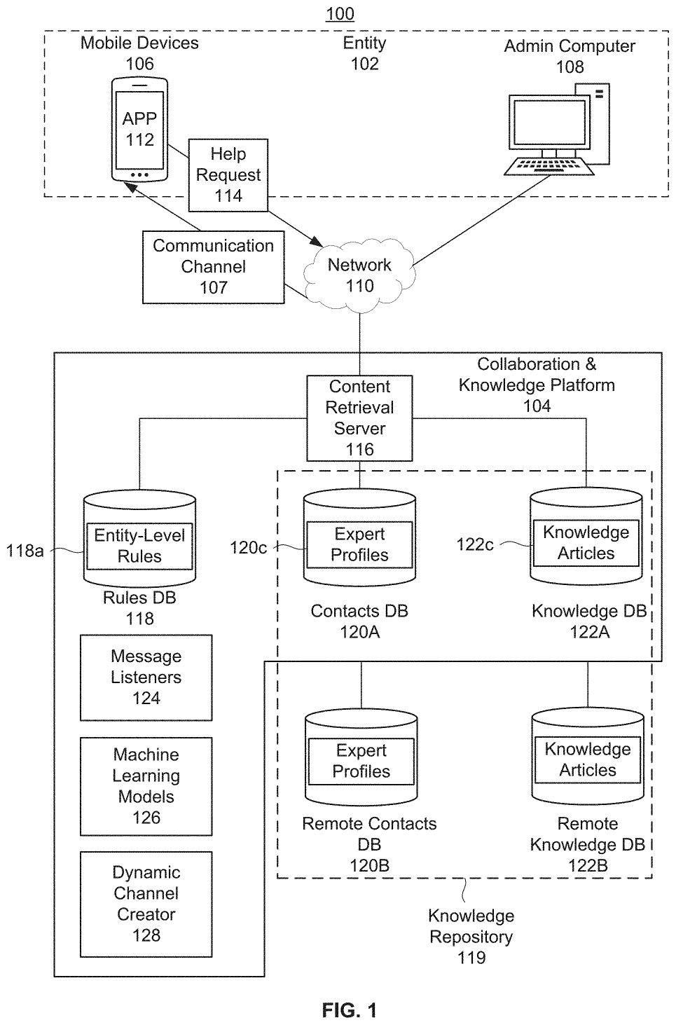

FIG. 1 is a block diagram illustrating a rule and context-based system 100 for collaboration between teams of users. In implementations, the rule and context-based system 100 may comprise at least one entity 102 and a collaboration and knowledge platform 104. The term entity 102 may refer to an organization that is formed to conduct business. The entity 102 may include personnel such as employees, contractors, and volunteers, collectively “users”, who perform job functions with the aid of an application program 112 executing on mobile devices 106. Examples of mobile devices 106 may include mobile phones, tablets and wearable devices (e.g., a smartwatch).

One problem faced by such types of users is how to find expert assistance at the right time, which has become increasingly difficult in the post Covid-19 new normal. Example types of expert assistance needed may include a field service technician who does not know how to fix an asset, a sales representative not knowing key stakeholders to close the deal, a service support agent who does not know how to assist a customer with a new product or service, and a medical volunteer who does not know to administer the Covid-19 vaccine.

With the advent of prevalent network connections to the Internet and other networks, preliminary or basic help documentation may be built in to the application program 112, but more substantive help documentation is often located at a resource accessible over the Internet. Existing forms of software may provide a help function to assist a user, but getting help often requires opening a separate help application. Seeking application program help, for example, results in accessing the documentation from a website. Sometimes an application program has a limited help interface and brings up a main access point for the help and the client then needs to indicate what program feature for which help is desired. Other times, the application program may provide a limited context sensitivity in that it may recognize the client is accessing a particular function of the application program and the help may automatically call up initial help for the particular function. To make use of the help the user must manually switch back and forth between the help system and the application program. This back-and-forth does not provide a smooth help experience, resulting in user frustration and wasted time, money and resources.

According to the disclosed implementations, the rule and context-based system 100 overcomes such challenges by placing the collaboration and knowledge platform 104 in network communication with the application program (hereinafter “app”) 112 executing on the mobile devices 106. The collaboration and knowledge platform 104 may comprise, among other components, a computer system that includes one or more content retrieval servers 116, a rules database 118, a knowledge repository 119, one or more message listeners 124, one or more machine learning models 126, and a dynamic channel creator 128. The knowledge repository 119 may comprise an internal contacts database 120A and a remote contacts database 120B (collectively referred to as contacts database 120) that contain a list of contacts as expert profiles 120C. As used herein, a profile comprises personal data associated with a specific user.

The knowledge repository 119 may further comprise an internal knowledge database 122A and a remote knowledge database 122B (collectively referred to as knowledge database 122) that store knowledge articles 122c. The knowledge articles 122c refer to collection of documentation that typically includes answers to frequently asked questions, how-to guides, and troubleshooting instructions. The purpose of the knowledge articles 122c is to make it easy for users to find solutions to their problems.

Although only one entity 102 is illustrated in FIG. 1, in other implementations more than one entity 102 may be supported by the collaboration and knowledge platform 104 to create a multi-tenant system, where each tenant has their own instance of the rules database 118 and knowledge repository 119.

As the user interacts with the app 112, a user interface (UI) of the app 112 shows current tasks assigned to the user and an option for the user to request expert assistance. In one implementation, UI actions and a state of the application may be monitored and used to formulate a current context of the user. When the user requests expert assistance, the app 112 generates and transmits to the communication and knowledge platform 104 a help request 114, which includes the current context of the app 112, including the current task being performed. The collaboration and knowledge platform 104 is a configuration rules and context-based system that uses the current context of the user and entity-level rules 118a stored in the rules database 118 to define how the collaboration and knowledge platform 104 provides expert recommendations. The collaboration and knowledge platform 104 uses the entity-level rules 118a predefined by the entity 102 to perform context-based matching of the user and the current task to a set of experts, and to automatically create a communication channel 107 between the user and the set of experts based on the entity-level rules 118a. The communication channel 107 is opened in the mobile device 106 of the user and computer devices of the matching experts, enabling the user to collaborate with the experts in real time.

In a further implementation, the collaboration and knowledge platform 104 also uses the entity-level rules 118a to automatically perform context-based matching of the user and the current task to a set of knowledge articles 122c stored in the knowledge database 122. The matching knowledge articles 122c may be returned to the app 112 for display in the UI to the user in addition to, or instead of, creation of a communication channel 107. The knowledge articles 122c may be sent directly to the app 112 or links (e.g., URLs) to the knowledge articles 122c may be sent to the app 112 for user selection.

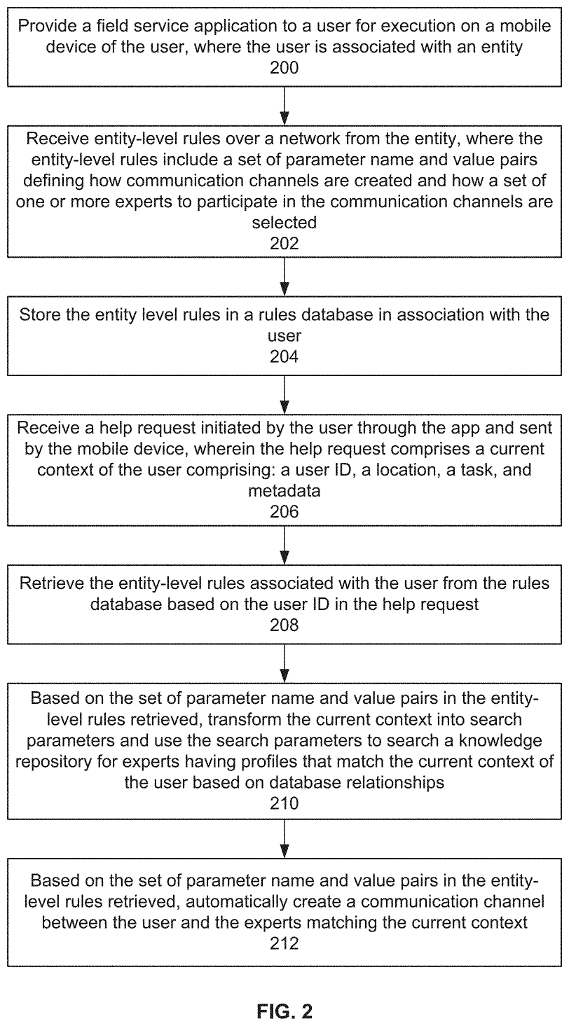

FIG. 2 is a flow diagram illustrating a process for automatic context-based matching of a user to a set of experts and creation of a communication channel. The process may begin by providing a field service application to a user for execution on a mobile device of the user, where the user is associated with an entity (block 200).

In one implementation, the application program (“app”) 112 is provided by the collaboration and knowledge platform 104 or an entity controlling the collaboration and knowledge platform 104 for execution on the mobile devices 106. For example, the app 112 may be made commercially available in an app store, made available for direct download from the collaboration and knowledge platform 104 or another website, or may be pre-installed on the mobile device 106 when given to the user.

During a configuration phase, a computer system of the knowledge platform 104, such as the content retrieval server 116 or another server, may receive entity-level rules 118a over the network from the entity 102, where the entity-level rules include a set of parameter name and value pairs defining how communication channels are created and how a set of one or more experts to participate in the communication channels are selected (block 202).

In one implementation, in addition to the mobile devices 106 that execute the application program (hereinafter “app”) 112, the entity 102 may include an administrative computer system (hereinafter “admin computer”) 108 to configure the entity-level rules 118a. As used herein, the admin computer 108 may comprise any computing system that directly or indirectly deals with or supports administrative or other information that is an integral part of running the business of the entity 102. As an administrator, a user would use the admin computer 108 to configure the entity-level rules 118a for users associated with the entity 102. In another implementation, the entity-level rules 118a may be configured for individual users in addition to, or instead of, being configured at the entity-level.

Both the mobile devices 106 and the admin computer 108 are in electronic communication with the collaboration and knowledge platform 104 through a network 110. For example, the mobile devices 106 may be in network communication with the collaboration and knowledge platform 104 via a wireless cellular and/or Wi-Fi network, while the admin computer 108 may be in network communication with the collaboration and knowledge platform 104 via a wired (e.g., Ethernet) or wireless network (e.g., Wi-Fi, Wi-Max and the like).

In one implementation, the entity-level rules 118a comprise a plurality of parameters that define how the knowledge platform 104 should i) automatically perform context-based matching of the user and the current task to a set of experts selected from expert profiles stored in the contacts DB 120 to participate in the communication channel with the user, ii) determine how the dynamic communication channels 107 should be created, and iii) automatically perform context-based matching of the user and the current task to a set of knowledge articles 122c from the knowledge database 122 to recommend and return to the app 112.

In one implementation, the entity-level rules may comprise a plurality of parameters including: an entity Name or ID parameter identifying the entity, an action label parameter identifying a type of action to perform, a channel rule type parameter indicating a type of communication channel to be created (e.g., a chat bot, or a telephone or video conference), a participant rule type defining how experts are selected, and a UI component parameter indicating a format of the UI of the app 112, and a channel name parameter identifying a name for the communication channel. When the channel rule type parameter indicates that the communication channel comprises a chat session, the message listeners 124 may be used to provide relevant chat bot recommendations/suggestions to the user within the chat session based on the knowledge articles 122c.

Once entered by the user, the content retrieval server 116 may store the entity-level rules 118a in the rules database 118 in association with the user (block 204). Each entity 102 serviced by the collaboration and knowledge platform 104 may have their entity-level rules 118a stored in the same rules database 118. In an alternative implementation, the entity-level rules 118a of each entity 102 may be stored in separate rule databases.

During operation of the app 112, the content retrieval server 116 may receive a help request initiated by the user through the app 112 and sent by the mobile device 106, where the help request comprises a current context of the user comprising: a user identifier (ID), a task ID of a current task of the task currently being performed by the user as determined from the app 112, a location, and metadata (block 206).

The user ID identifies the user and the task ID identifies the current task or asset being worked on. The user ID or the task ID may comprise or include a record ID and/or an entity ID. The location indicates the location of the mobile device 106 and therefore the user, as determined by GPS, Wi-Fi, or cell tower triangulation. The context may also include metadata, such as i) a state of the app 112, ii) information about the environment of the mobile device/user such as the telephone number, weather, time, date, elevation and the like, iii) physiological/bioinformatics data of the user captured by the mobile device and/or a mobile device accessories such as a smartwatch, or any combination thereof. Examples of physiological/bioinformatics data may include heart rate, temperature, steps walked, a selfie image, and the like.

In one implementation, the app 112 comprises a context aware application that is capable of tracking the state of the app 112 and the task being performed by the user. It will be appreciated an application program may be a standalone product and/or implemented in another format, such as a web-based network-aware application as may be implemented in conjunction with a web browser or similar software environment. In the one implementation, a browser implementation for an application program may be employed. In this implementation, the browser may display a web page as an application program interface. Within the interface, there may be a Uniform Resource Locator (URL) identifying the present location within the application program. While the user accesses the User Interface (UI) of the application program, events are generated, e.g., generating click events for elements in the interface, focus change events, keyboard (typing) events, etc.

Various accesses and/or events corresponding to interactions with the UI may change the content of the URL in accord with the accesses. For example, if the user drills down to successive layers of options in a program feature, each UI access to get to a new location in the application program may result in successive changes to the URL. These URL changes may be monitored and used to determine a hierarchy of accesses to the UI and in turn used to provide help content relevant not only to a particular application program function or feature currently being accessed by a client, but also relevant to the hierarchy and/or history of accesses that led to the current application program function/feature. As a more specific example, assume the application program provides a plumber with a schedule of appointments as well as what needs to be fixed during each appointment. Accesses of the UI may be monitored, and a hierarchy of contexts may be derived and stored by the app 112 and/or the content and retrieval server (storing may be in the mobile device 106 and/or in a server cache). UI access may indicate accessing the application program feature to, for example, view the scheduled appointments, then track UI access for selecting the current appointment, then track UI access for selecting information about an asset to be fixed, and then track UI access for a particular application program function, such as to request help or “Expert Assistance”.

Each of these accesses changes the URL and the sequence of accesses, may be used to provide a meaningful derived hierarchical context of how the Help function had been reached. This context may represent more than simply where the user is currently in the app 112 and instead may indicate how the user arrived there, e.g., what accesses led to this current state of the application program. Thus, hierarchically-relevant context-aware help content may be determined.

Responsive to receiving the help request, the content retrieval server 116 may retrieve the entity-level rules 118a associated with the user from the rules database 118 based on the user ID or the task ID from the help request (block 208).

Based on the set of parameter name and value pairs in the entity-level rules 118a retrieved, the current context is transformed into search parameters, and the search parameters are used to search knowledge repository 119 for experts having profiles that match the current context of the user based on database relationships (block 210). In a further implementation, the search parameters may be used to search the knowledge repository 119 (i.e., knowledge database 122A and/or 122B) for a set of knowledge articles 122c that may match the context of the user and the current task. The matching knowledge articles 122c may be returned to the app 112 for display in the UI to the user.

According to one implementation, the current context may be transformed into search parameters using one or more machine learning models 126. In certain implementations, the search parameters may take the form of one or more vectors. For example, a text vectorizer may be provided to compute vectors for respective text units of the current context. The text vectorizer may compute a given vector for a given text unit by: (i) computing word vectors for respective words in the text unit; (ii) computing phrase vectors for respective phrases in the text unit; and (ii) combining the word vectors and the phrase vectors to produce the given vector for the given text unit.

The text vectorizer may further compute corpus vectors for the respective corpus documents comprising the expert profiles 120C in the contacts DB 120A and 120B, and the knowledge articles 122c in the knowledge bases 122A and 122B in the knowledge repository 119. Computation of the corpus vectors may be performed as each document/record is added to the knowledge repository 119, rather than in real-time during a search. The corpus vectors are used to form the ML models 126. Once text of the current context is received, the text vectorizer computes a search vector from text comprising the current context. The search vector is input to ML models 126, which compares the search vector of the current context with the corpus vectors of the respective corpus documents and determines the relative distance of the search vector to the corpus vectors as indicated by search scores. The highest ones of the search scores for the respective corpus documents other and output. The expert profiles 120c and knowledge articles 122c having the highest search scores are returned.

Based on the set of parameter name and value pairs in the entity-level rules retrieved, a communication channel is automatically created between the user and the experts matching the current context, where the communication channel comprises one of a short message service (SMS) session, a video call, a voice call or email (block 212).

In one implementation, the automatically created communication channels may be referred to as “dynamic” communication channels in the sense that the communication channels are created “on the fly” and the communication channels created will be of different types and have different attendees based on contextual activity or progress of the user, the current task and the entity-level rules 118a associated with the user.

In one implementation, the content retrieval server 116 may invoke the dynamic channel creator 128 using a rest API to create the dynamic communication channels. In implementations, the dynamic channel creator 128 may create dynamic communication channels by determining from the entity-level rules 118a a specific type of communication channel to create and any specified user permissions. A meeting invitation link to the dynamic communication channel is then created, where the meeting invitation link includes the user ID and a URL associated with a meeting room of the user. The link may also include a telephone number for attendees to join with audio. The link is then sent to addresses associated with the experts and the app 112 for display in the UI, such that when the user of the app 112 and the matching experts click their respective links, the respective links cause the user and experts to join in the dynamic communication channel to form a group meeting between the user and the experts. In another implementation, the communication channel may be automatically opened and displayed in the UI of the app 112 to the user such as where the communication channel comprises a messaging channel for example.

According to the implementations disclosed herein, the entity-level rules provided by the rule and context-based system 100 are easily configurable by entities to provide mobile device users with the context-based matching of experts and knowledge articles. The collaboration and knowledge platform 104 leverages user interaction with the application program 112 to determine relevant context based on the user, the current task, location, environment and biometrics. The collaboration and knowledge platform 104 uses the relevant context of the user to automatically select experts and create dynamic communication channels between the user and the experts and to select knowledge articles to recommend the user for enhanced collaboration and assistance with their tasks. Consequently, the rule and context-based system 100 dispenses with the need for the user to search for help manually or to switch a different application to get needed help.

It will be appreciated the content retriever server 116 may identify characteristics associated with monitored UI accesses. For example, the server may analyze a derived hierarchical context to identify what the user has accessed, such as a particular type of product or service, and use associated characteristic and/or other identified characteristics associated with the derived context, to update and/or refine help content provided to the user. It will be appreciated that the implementation of the app UI containing corresponding hierarchically-relevant context-aware help content may be referred to as a dynamically updateable context-aware help service. It will be further appreciated the illustrated configuration of the various portions and/or component of the application program interface are exemplary and may change and/or be differently organized and/or configured based on the entity-level rules without departing from the teachings presented herein.

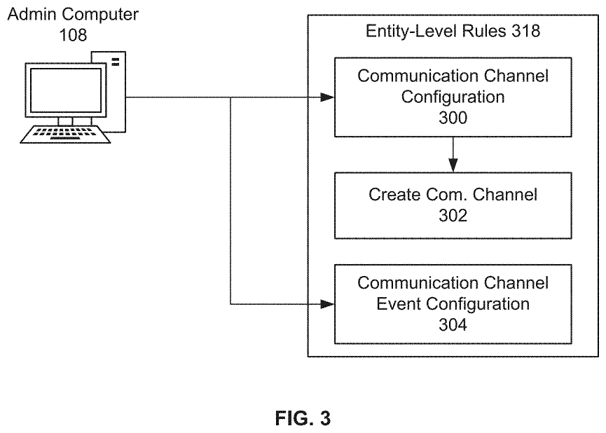

FIG. 3 is a diagram illustrating the process of configuring the entity-level rules 318 by the admin computer 108 in further detail. A user of the admin computer 108 first navigates to a website of the collaboration and knowledge platform 104 hosting a rule setup page. In implementations, the rule setup page may display various parameters with selectable lists of values for the user to choose from for communication channel configuration 300 and communication channel event configuration 304. The communication channel configuration 300 may define the type of communication channels created and controls how experts are selected. The communication channel event configuration 304 may define what type of messages are displayed in a chatbot session and how user entered messages are interpreted.

An entity 102 can have multiple such entity-level rules 318 defined. As an example, the rule setup page may display for the communication channel configuration 300 a set of parameter name and value pairs, such as the following:
** Dynamic Channel Configuration Rules ***
Entity Name: TEXT (e.g., “Ajax Plumbing”)
Quick Action Label: TEXT (e.g., “Expert Assistance”)
Channel Rule Type: COM. CHANNEL SELECTION LIST (e.g., SMS, Video Call, Voice Call, Email)
Participant Rule Type: SELECTION LIST (e.g., Machine Learning/Teams/History)
UI Component: SELECTION LIST (e.g., Default compact UI/Custom UI)
Channel Name: TEXT

The value entered for the Entity Name parameter is the name of the entity 102, e.g., “Ajax Plumbing”, which is a customer of the collaboration and knowledge platform 104. The value entered for the Quick Action Label parameter specifies a label, e.g., “Expert Assistance”, which is automatically displayed to the user in the UI of the app 112 to request assistance/help. As used herein, Quick Actions are provided by the collaboration and knowledge platform 104 and have automatic relationships to other records, e.g., tasks and/or users. Quick Actions may support Apex and JavaScript and provide a secure way to build client-side custom functionality. Quick Actions can be added to any app or page configured to support such actions.

The value entered for the Channel Rule Type parameter defines what type of communication channel 302 will be created. The value a selected from a set of predefined channel rule type parameter values including SMS, Video Call, Voice Call, or Email. In one implementation, there may be more than one value per channel type. For instance, there may be several video call values to select based on different video call providers, such a ZOOM, HANGOUTS, SKYPE, TEAMS, and the like. In another implementation, the collaboration and knowledge platform 104 may have default providers for each of channel type.

The value entered for the Participant Rule Type parameter defines how experts of the communication channel are selected. Once invoked, Participant Rule Type parameter results in the return of a list of experts from the contacts DB 120. The value is selected from a set of predefined Participant Rule Type values including i) “Machine Learning” that specifies that the group of experts will be selected by context-based matching by the machine learning models 126, ii) “Teams” that specifies that the group of experts will be selected from any experts currently assigned to work on the task record ID, and iii) “History” that defines a group of experts that has ever worked on the task record ID. The Teams and History values may be workflow based.

The value entered for the UI Component parameter specifies whether the UI is to display the channel is to be presented using a default compact UI of the platform or use a customized UI, as specified by the admin.

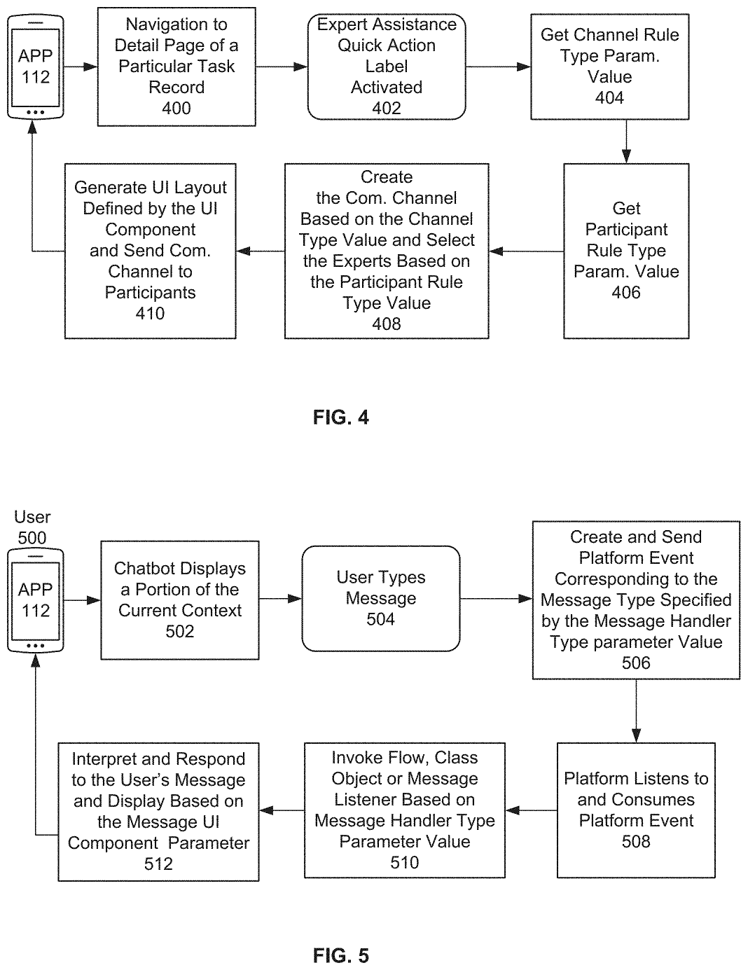

FIG. 4 is a diagram illustrating processing of the communication channel configuration 300 of the entity-level rules 318 by the collaboration and knowledge platform. The process may begin when the user navigates to a detail page of a task record in the app 112 (block 400), and activates (e.g., clicks on) a displayed Expert Assistance Quick Action Label (block 402).

In response, the app 112 sends the help request 114 with the current context, including the user ID and task ID to the content retrieval sever 116. The content retrieval server 116 uses the user ID included as part of the context of the help request 114 to lookup the associated entity-level rules 118a and retrieve the Channel Rule Type parameter value (block 404) and the Participant Rule Type parameter value (block 406) from the communication channel configuration 300.

The collaboration and knowledge platform 104 then invokes the dynamic channel creator 128 to create a communication channel 302 based on the Channel Rule Type parameter value, and selects the experts to participate in the communication channel 302 based on the Participant Rule Type parameter value (block 408). The dynamic channel creator 128 also moves the user who invoked the Quick Action communication channel 302 and the selected expert participants into the communication channel 302. In one implementation, the dynamic channel creator 128 associates a channel ID with the communication channel 302.

The dynamic channel creator 128 or another component generates the UI layout defined by the UI component of the communication channel configuration 300, and the communication channel 302 is sent, e.g., via a link, to the user's app 112 as well as to the respective apps of the expert participants (block 410).

In a further implementation as part of the Quick Action, the record ID or task ID on which the quick action is invoked may be used by the content retrieval server 116 to push a chatbot message to the UI of the app 112 to provide additional help for the user. Referring again to FIG. 3, the chatbot message is defined using the communication channel event configuration 304.

As used herein, a chatbot or bot is a computer program that conducts a conversation with a user via text although an auditory method may also be used. In implementations, one or more message listeners 124 implement the chatbot messages that are sent to the app 112. In one implementation, the message listeners 124 may be implemented as smart assistants that can perform and automate tasks. This allows admins and developers to build a customized smart assistant that uses voice input, natural language understanding, voice output, intelligent interpretation, and agency components to provide improved help for user of the entity 102. Using such technology provides the smart assistant with the ability to understand what the user is saying/typing and to respond accordingly. In one implementation, the message listener 124 may implement the chatbots using one or more of the ML models 126 that perform natural language understanding.

For example, the entity 102 can configure the communication channel event configuration 304 such that the message listeners 124 displays the current context of the user's task when first chatbot message is displayed in the UI of the app 112. The communication channel event configuration 304 can be configured to provide relevant chatbot recommendations or suggestions to the user, such as relevant knowledge articles 122c.

As an example, an admin rule setup page may display for the collaboration channel event configuration 304 a set of parameter name and value pairs, such as the following:

* * * DynamicChannelMessageConfig * * *

DynamicChannelConfigID: TEXT (e.g., User ID, Task ID or Channel ID)

Message Handler Type: SELECTION LIST (e.g., Flow/Class Object/ML Message Handler)

Message UI Component: SELECTION LIST (e.g., Default compact UI/Custom UI)

The value entered for the DynamicChannelConfigID parameter is specifies whether the chatbot message will be associated with the User ID, the Task ID, Channel ID or a combination thereof. The value entered for the Message Handler Type defines whether knowledge articles 122c or additional recommendations displayed in the chatbot message are based a workflow, an object class, or on the use ML/NLP or other algorithms. The Message UI Component parameter specifies how the chatbot message is to be presented in the UI of the app 112. The value entered for the Message UI Component parameter specifies whether the UI is to display the chatbot message using the default compact UI or a customized UI, as specified by the admin.

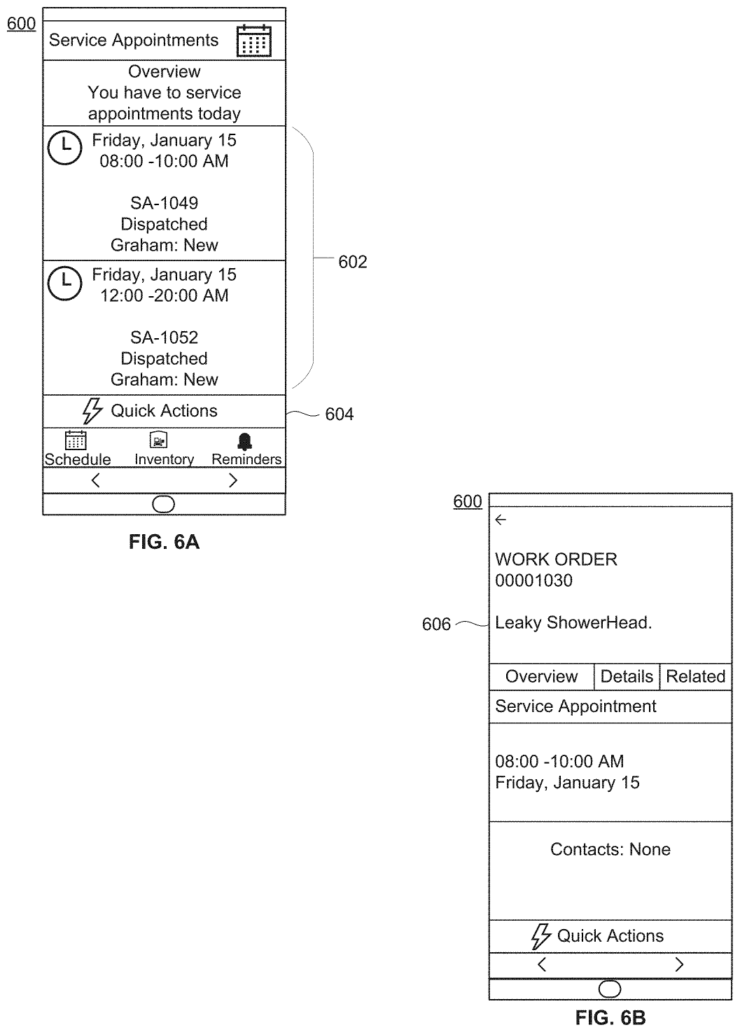

FIG. 5 is a diagram illustrating processing of the collaboration channel event configuration 304 of the entity-level rules 318 by the collaboration and knowledge platform. The process begins when the chatbot is displayed in the UI of the app 112 and shows at least a portion of the current context from the help request 114 and may ask the user 500 if they need assistance (block 502). A connection between the chatbot and the collaboration and knowledge platform 104 is automatically created. The chatbot may also be displayed to the expert participants in one implementation. In one implementation, the entity 102 may establish authorization levels for different users based on roles, tasks and the like that must be met before interaction with the chatbot is authorized.

The user may type in a message or question into the chatbot (block 504). In response, a platform event is created and sent to the collaboration and knowledge platform 104 corresponding to the message type as specified by the Message Handler Type parameter value (block 506). The platform event is then listened to and consumed along with metadata such as the channel ID etc. (block 508). Based on the Message Handler Type parameter value, a flow, class object or a message listener 124 is invoked (block 510), which then interprets and respond to the user's message (block 512).

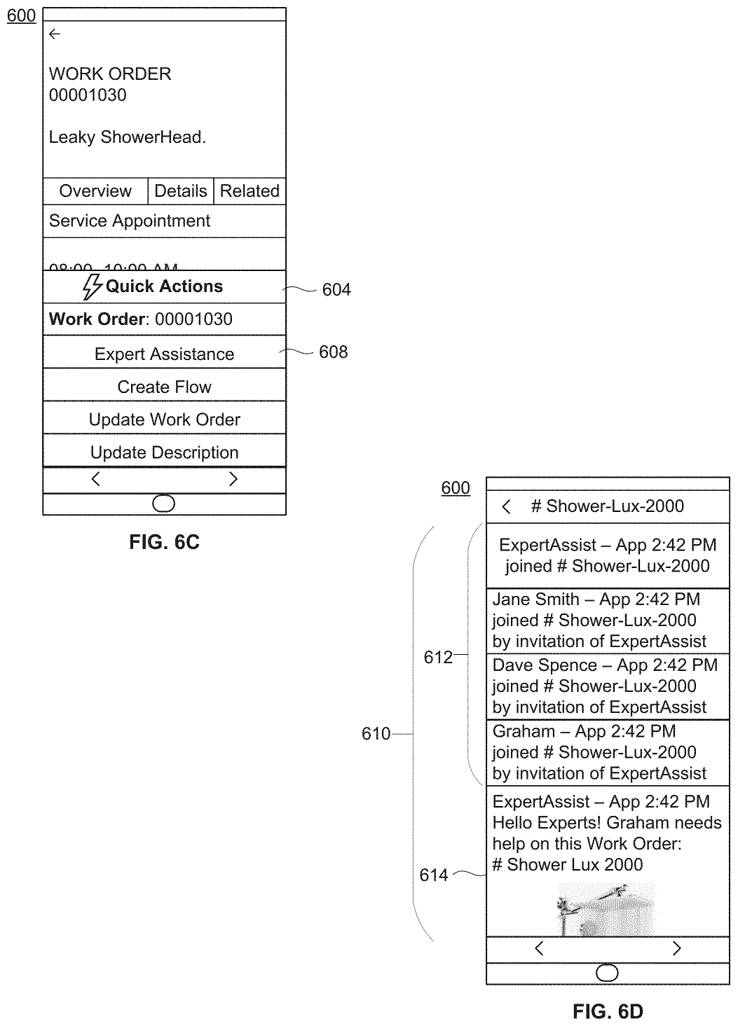

FIGS. 6A-6B are diagrams illustrating an example application program user interface (UI) 600 for implementing the context and rule based dynamic communication channels according to one implementation. In this example, the application program UI 600, or simply the app UI 600, comprises a field service application for use by a field technician, such as a plumber, which is the user of the app UI 600.

FIG. 6A shows that the app UI 600 displays dates and times for scheduled tasks 602, which in this case are service appointments that are scheduled for the user named Graham. The app UI 600 also displays a “Quick Actions” menu 604, where some of the options for which are defined by the entity through the entity-level rules.

FIG. 6B shows that in response to the user clicking on the first service appointment the app UI 600 indicates that the task 606 is to fix a leaky showerhead. The app UI 600 may display a “Details” option that the user can select to see additional information about the object being worked on, such as the make and model of the showerhead. In this example, the task 606 is unfamiliar to the user Graham because he is a new technician and the showerhead is new to the market.

FIG. 6C shows that since the user does not know how to fix the showerhead, the user clicks on the “Quick Actions” menu 604, which causes the app UI 600 to display several Quick Action options, one of which is an “Expert Assistance” option 608. The “Quick Actions” menu 604 is shown displayed overlaid over other elements of the UI in this example. The user clicks on “Expert Assistance” option 608 to request expert assistance. In response, the app gathers and sends the current context from the technician's mobile phone to the knowledge and collaboration platform. For example, the current context may include information about the user, the mobile device, and the task being performed. The information about the task may include the make and model of the showerhead for instance.

FIG. 6D shows that after the knowledge and collaboration platform uses the current context to find experts having profiles matching the current context, the platform automatically opens a communication channel, which is a chat session 610 in this example, and is displayed in the app UI 600. The chat session 610 may display messages 612 introducing participants that have been added to the chat session, whom in this case are Graham, two experts Jane and Dave, and an Expert Assist chatbot controlled by one of the message listeners 124. An interface similar to what is displayed on the user's mobile device would be displayed on the devices of the two experts. It should be noted that the knowledge and collaboration platform may send the experts an invitation link to the chat session, and each expert must first accept the invitation to be added to the chat session 610. The Expert Assist chatbot may also display an introductory message 614 stating that Graham needs assistance with a work order to fix a showerhead. The make and model of the showerhead may also be displayed.

FIG. 6E shows that Graham types in a message 616 that he needs help because the showerhead is leaking. In another implementation, the problem with the showerhead may be displayed as part of the current context. Before the experts can reply, the Expert Assist chatbot displays a message 618 providing links to recommended knowledge articles about what might be common causes of a “leaking faucet”. The experts may also offer suggestion, although not shown in this example.

FIG. 6F shows that after perusing one or more of the knowledge articles and perhaps reading any messages from the experts, Graham types in a message 620 informing the experts and the Expert Assist chatbot that the issue has been resolved. Using natural language processing provided by one of the machine learning models 126, the Expert Assist chatbot understands that Graham's message 620 indicates the issue is resolved and displays a confirmation message 622. The Expert Assist chatbot also requests feedback to improve the system. For example, the Expert Assist chatbot may ask if the problem was resolved and if so how. Graham can then type in a solution, e.g., “I fixed the O-ring”, which is added to the knowledge database 122 to help other technicians in the future.

Example Electronic Devices and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

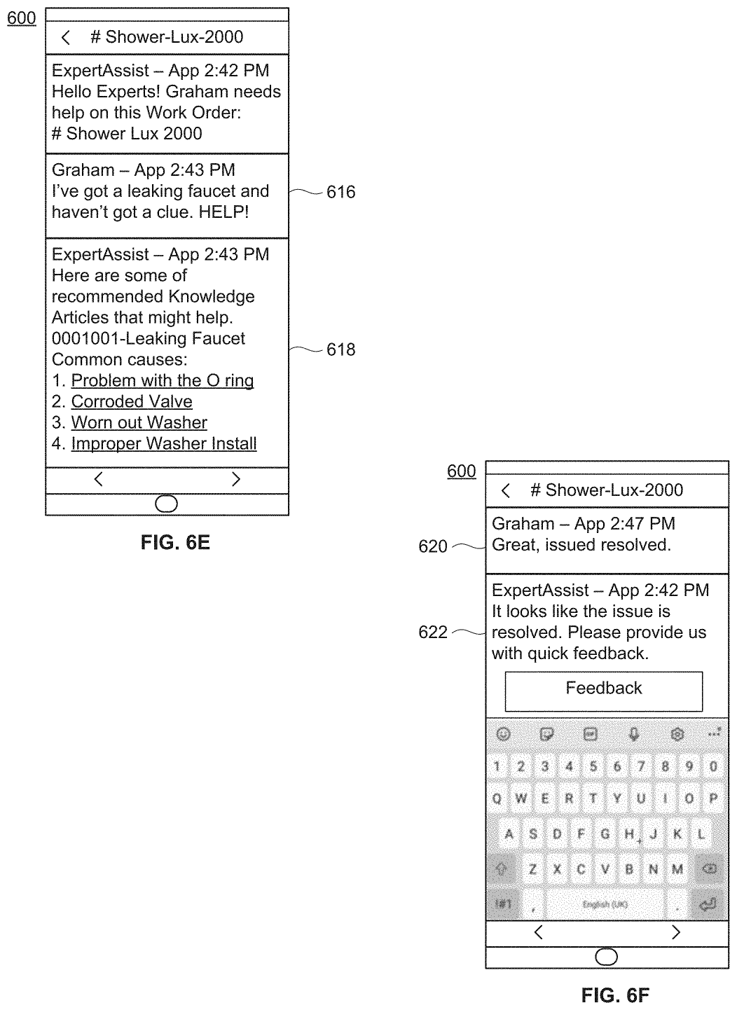

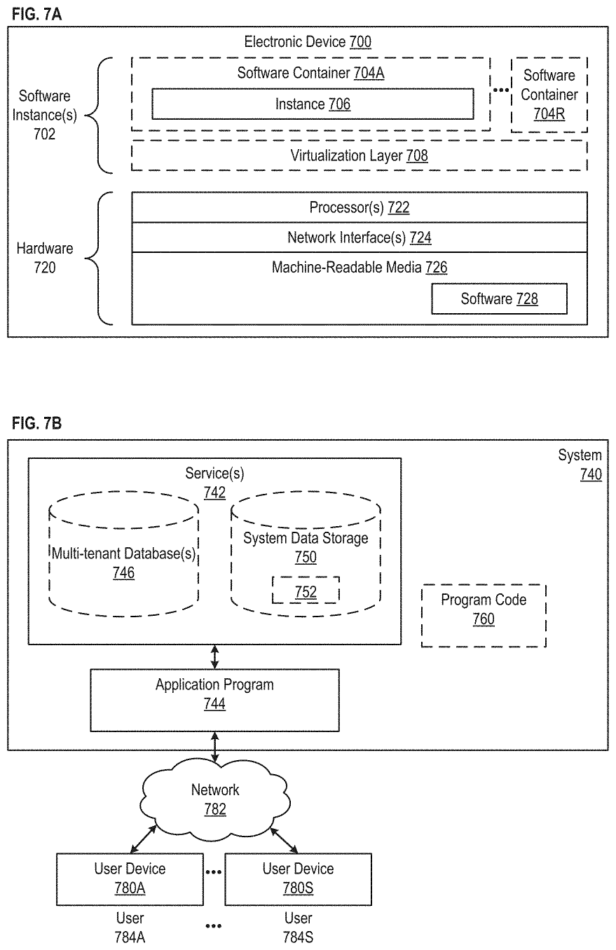

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 726 may include non-transitory and/or transitory machine-readable media. Each of the previously described clients and the rule and context-based system may be implemented in one or more electronic devices 700. In one implementation: 1) each of the clients is implemented in a separate one of the electronic devices 700 (e.g., in end user mobile devices where the software 728 represents the software to implement clients to interface directly and/or indirectly with the collaboration and knowledge platform (e.g., software 728 represents a web browser, a native client, a portal, a command-line interface, and/or an application programming interface (API) based upon protocols such as Simple Object Access Protocol (SOAP), Representational State Transfer (REST), etc.)); 2) the collaboration and knowledge platform is implemented in a separate set of one or more of the electronic devices 700 (e.g., a set of one or more server devices where the software 728 represents the software to implement the collaboration and knowledge platform); and 3) in operation, the electronic devices implementing the clients and the collaboration and knowledge platform would be communicatively coupled (e.g., by a network) and would establish between them (or through one or more other layers and/or or other services) connections for submitting help request to the content retrieval server part of the collaboration and knowledge platform and returning expert assistance to the client. Other configurations of electronic devices may be used in other implementations (e.g., an implementation in which the client and the collaboration and knowledge platform are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and one or more software container(s) 704A-704R (e.g., with operating system-level virtualization, the virtualization layer 708 may represent a container engine (such as Docker Engine by Docker, Inc. or rkt in Container Linux by Red Hat, Inc.) running on top of (or integrated into) an operating system, and it allows for the creation of multiple software containers 704A-704R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-704R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. The instantiation of the instance 706, as well as the virtualization layer 708 and software containers 704A-704R if implemented, are collectively referred to as software instance(s) 702.

Alternative implementations of an electronic device may have numerous variations from that described above. For example, customized hardware and/or accelerators might also be used in an electronic device.

### Example Environment

FIG. 7B is a block diagram of a deployment environment according to some example implementations. A system 740 includes hardware (e.g., a set of one or more server devices) and software to provide service(s) 742, including the rule and context-based system. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 740 is coupled to user devices 780A-780S over a network 782. The service(s) 742 may be on-demand services that are made available to one or more of the users 784A-784S working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users 784A-784S). The service(s) 742 may communicate with each other and/or with one or more of the user devices 780A-780S via one or more APIs (e.g., a REST API). In some implementations, the user devices 780A-780S are operated by users 784A-784S, and each may be operated as a client device and/or a server device. In some implementations, one or more of the user devices 780A-780S are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 740 is a multi-tenant cloud computing architecture supporting multiple services, such as one or more of the following types of services: Dynamically updateable context-aware help; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 740 may include an application platform 744 that enables PAAS for creating, managing, and executing one or more applications developed by the provider of the application platform 744, users accessing the system 740 via one or more of user devices 780A-780S, or third-party application developers accessing the system 740 via one or more of user devices 780A-780S.

In some implementations, one or more of the service(s) 742 may use one or more multi-tenant databases 746, as well as system data storage 650 for system data 652 accessible to system 740. In certain implementations, the system 740 includes a set of one or more servers that are running on server electronic devices and that are configured to handle requests for any authorized user associated with any tenant (there is no server affinity for a user and/or tenant to a specific server). The user devices 780A-780S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the multi-tenant database(s) 746 and/or system data storage 650.

In some implementations, the service(s) 742 are implemented using virtual applications dynamically created at run time responsive to queries from the user devices 780A-380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the collaboration and knowledge platform, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th}generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780A-780S.

Each user device 780A-780S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784A-784S to interact with various GUI pages that may be presented to the one or more of users 784A-784S. User devices 780A-780S might communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 780A-780S might include an HTTP client, commonly referred to as a “browser,” for sending and receiving HTTP messages to and from server(s) of system 740, thus allowing users 784A-784S of the user devices 780A-780S to access, process and view information, pages and applications available to it from system 740 over network 782.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations assuming for expository convenience use of a browser to implement all or selected aspects of the dynamically updateable context-aware help service, the invention is not limited to the implementations described and can be practiced with modification and alteration within the spirit and scope of the appended claims. The description is thus illustrative instead of limiting.

What is claimed is:

1. A method, comprising:
providing an application program for execution on a mobile device of a user, the user associated with an entity;
receiving, by a computer system of a knowledge platform, entity-level rules over a network from the entity, the entity-level rules including a set of parameter name and value pairs defining how communication channels are created and how a set of one or more experts to participate in the communication channels are selected;
storing, by the computer system, the entity-level rules in a rules database in association with the user;
receiving, by the computer system, a help request initiated by the user through the application program and sent by the mobile device, the help request comprising a current context of the user, the current context comprising: a user identifier (ID) and a task ID of a current task;
retrieving, by the computer system, the entity-level rules associated with the user from the rules database based on the user ID or the task ID;
based on the set of parameter name and value pairs in the entity-level rules retrieved, transforming the current context into search parameters and using the search parameters to search a knowledge repository for the experts having profiles that match the current context of the user based on database relationships; and
based on the set of parameter name and value pairs in the entity-level rules retrieved, automatically creating a communication channel between the user and the experts matching the current context, the communication channel comprising one of a short message service (SMS), a video call, a voice call or email.

2. The method of claim 1, further comprising including in the entity-level rules a first parameter name and value pair that defines how the computer system should automatically perform context-based matching of the user and the current task to a set of experts selected from expert profiles stored in a contacts database to participate in the communication channel with the user.

3. The method of claim 2, further comprising including in the entity-level rules a second parameter name and value pair that defines how the computer system should automatically perform context-based matching of the user and the current task to a set of knowledge articles stored in the knowledge repository to recommend and return to the application program.

4. The method of claim 1, further comprising including in the entity-level rules: i) an entity Name or ID parameter name and value pair identifying the entity; ii) an action label parameter name and value pair identifying a type of action to perform; iii) a channel rule type parameter name and value pair indicating a type of communication channel to be created, including a chat bot, a telephone conference or video conference; iv) a participant rule type parameter name and value pair defining how the experts are selected, and v) a user interface (UI) parameter name and value pair indicating a format of the UI of the app.

5. The method of claim 1, further comprising including in the current context a location of the mobile device and metadata, wherein the metadata comprises i) a state of the app, ii) information about an environment of the mobile device or the user, or iii) physiological/bioinformatics data of the user captured by the mobile device or a mobile device accessory.

6. The method of claim 1, further comprising using the search parameters to search the knowledge repository for knowledge articles that match the current context and returning the matching articles for display in a user interface of the application program.

7. The method of claim 1, further comprising transforming the current context into search parameters using one or more machine learning models.

8. The method of claim 7, further comprising:
computing corpus vectors for respective corpus documents comprising expert profiles and knowledge articles in the knowledge repository;
using the corpus vectors to form the one or more machine learning models;
computing a search vector from text comprising the current context;
inputting the search vector to the one or more ML models, which compare the search vector of the current context with the corpus vectors of the respective corpus documents and determining a relative distance of the search vector to the corpus vectors as indicated by search scores; and
outputting highest ones of the search scores for the respective corpus documents.

9. The method of claim 1, further comprising automatically creating the communication channel by:
determining from the entity-level rules a specific type of communication channel to create;
creating a link to the communication channel, the link including the user ID and a universal resource locator (URL) associated with a meeting room of the user; and
sending the link to addresses associated with the experts and the application program for display in the user interface, such that when the experts click their respective links, the respective links cause the experts to join in the dynamic communication channel to form a group meeting between the user and the experts.

10. A non-transitory machine-readable storage medium that includes instructions for providing help to a user accessing a network-based application having a user interface (UI), the instructions when executed by a processor are configurable to cause the processor to perform operations comprising:
providing an application program for execution on a mobile device of the user, the user associated with an entity;
receiving, by a computer system of a knowledge platform, entity-level rules over a network from the entity, the entity-level rules include a set of parameter name and value pairs defining how communication channels are created and how a set of one or more experts to participate in the communication channels are selected;
storing, by the computer system, the entity-level rules in a rules database in association with the user;
receiving, by the computer system, a help request initiated by the user through the application program and sent by the mobile device, the help request comprising a current context of the user, the current context comprising: a user identifier (ID) and a task ID of a current task;
retrieving, by the computer system, the entity-level rules associated with the user from the rules database based on the user ID or the task ID;
based on the set of parameter name and value pairs in the entity-level rules retrieved, transforming the current context into search parameters and using the search parameters to search a knowledge repository for the experts having profiles that match the current context of the user based on database relationships; and
based on the set of parameter name and value pairs in the entity-level rules retrieved, automatically creating a communication channel between the user and the experts matching the current context, the communication channel comprising one of a short message service (SMS), a video call, a voice call or email.

11. The machine-readable storage medium of claim 10, further comprising instructions for including in the entity-level rules a first parameter name and value pair that defines how the computer system should automatically perform context-based matching of the user and the current task to a set of experts selected from expert profiles stored in a contacts database to participate in the communication channel with the user.

12. The machine-readable storage medium of claim 11, further comprising instructions for including in the entity-level rules a second parameter name and value pair that defines how the computer system should automatically perform context-based matching of the user and the current task to a set of knowledge articles stored in the knowledge repository to recommend and return to the application program.

13. The machine-readable storage medium of claim 10, further comprising instructions for including in the entity-level rules: i) an entity Name or ID parameter name and value pair identifying the entity, ii) an action label parameter name and value pair identifying a type of action to perform; iii) a channel rule type parameter name and value pair indicating a type of communication channel to be created, including a chat bot, a telephone conference or video conference; iv) a participant rule type parameter name and value pair defining how the experts are selected, and v) a user interface (UI) parameter name and value pair indicating a format of the UI of the app.

14. The machine-readable storage medium of claim 10, further comprising instructions for including in the current context a location of the mobile device and metadata, wherein the metadata comprises i) a state of the app, ii) information about an environment of the mobile device or the user, or iii) physiological/bioinformatics data of the user captured by the mobile device or a mobile device accessory.

15. The machine-readable storage medium of claim 10, further comprising instructions for using the search parameters to search the knowledge repository for knowledge articles that match the current context and returning the matching articles for display in a user interface of the application program.

16. The machine-readable storage medium of claim 10, further comprising instructions for transforming the current context into search parameters using one or more machine learning models.

17. The machine-readable storage medium of claim 16, further comprising instructions for:
computing corpus vectors for respective corpus documents comprising expert profiles and knowledge articles in the knowledge repository;
using the corpus vectors to form the one or more machine learning models;
computing a search vector from text comprising the current context;
inputting the search vector to the one or more ML models, which compare the search vector of the current context with the corpus vectors of the respective corpus documents and determining a relative distance of the search vector to the corpus vectors as indicated by search scores; and
outputting highest ones of the search scores for the respective corpus documents.

18. The machine-readable storage medium of claim 10, further comprising instructions for automatically creating the communication channel by:
determining from the entity-level rules a specific type of communication channel to create;
creating a link to the communication channel, the link including the user ID and a universal resource locator (URL) associated with a meeting room of the user; and
sending the link to addresses associated with the experts and the application program for display in the UI, such that when the experts click their respective links, the respective links cause the experts to join in the communication channel to form a group meeting between the user and the experts.

19. An apparatus comprising:
a set of one or more processors;
a non-transitory machine-readable storage medium that provides instructions for providing help to a user accessing a network-based application having a user interface (UI), the instructions when executed by the set of one or more processors are configurable to cause the apparatus to perform operations comprising,
providing an application program for execution on a mobile device of the user, the user associated with an entity;
receiving, by a computer system of a knowledge platform, entity-level rules over a network from the entity, the entity-level rules include a set of parameter name and value pairs defining how communication channels are created and how a set of one or more experts to participate in the communication channels are selected;
storing, by the computer system, the entity-level rules in a rules database in association with the user;
receiving, by the computer system, a help request initiated by the user through the application program and sent by the mobile device, the help request comprising a current context of the user, the current context comprising: a user identifier (ID) and a task ID of a current task;
retrieving, by the computer system, the entity-level rules associated with the user from the rules database based on the user ID or the task ID;
based on the set of parameter name and value pairs in the entity-level rules retrieved, transforming the current context into search parameters and using the search parameters to search a knowledge repository for experts having profiles that match the current context of the user based on database relationships; and
based on the set of parameter name and value pairs in the entity-level rules retrieved, automatically creating a communication channel between the user and the experts matching the current context, the communication channel comprising one of a short message service (SMS), a video call, a voice call or email.

20. The apparatus of claim 19, further comprising including in the entity-level rules a first parameter that defines how the computer system should automatically perform context-based matching of the user and the current task to a set of experts selected from expert profiles stored in a contacts database to participate in the communication channel with the user.

21. The apparatus of claim 20, further comprising including in the entity-level rules a second parameter that defines how the computer system should automatically perform context-based matching of the user and the current task to a set of knowledge articles stored in the knowledge repository to recommend and return to the application program.

22. The apparatus of claim 19, further comprising including in the entity-level rules: i) an entity Name or ID parameter name and value pair identifying the entity, ii) an action label parameter name and value pair identifying a type of action to perform; iii) a channel rule type parameter name and value pair indicating a type of communication channel to be created, including a chat bot, a telephone conference or video conference; iv) a participant rule type parameter name and value pair defining how the experts are selected, and v) a user interface (UI) parameter name and value pair indicating a format of the UI of the app.

23. The apparatus of claim 19, further comprising including in the current context a location of the mobile device and metadata, wherein the metadata comprises i) a state of the app, ii) information about an environment of the mobile device or the user, or iii) physiological/bioinformatics data of the user captured by the mobile device or a mobile device accessory.

24. The apparatus of claim 19, further comprising using the search parameters to search the knowledge repository for knowledge articles that match the current context and returning the matching articles for display in a user interface of the application program.

25. The apparatus of claim 19, further comprising transforming the current context into search parameters using one or more machine learning models.
